(19) United States
(12) Patent Application Publication
(10) Pub. No.: US 2007/0038541 A1
(43) Pub. Date: Feb. 15, 2007

(54) Monetary management affair survey device to reduce preparation and review costs, reduce errors, reduce time to compile, record and review, reduce amendments, and increase accuracy and improve advisory decisions

(76) Inventor: David Lawrence Tessitore, Ocoee, FL (US)

Correspondence Address: David Tessitore, 6440 Riley Manor Way, Cumming, GA, 30040, US

(21) Appl. No.: 11/117,048

(22) Filed: Jul. 29, 2005

(51) Int. Cl. G06Q 40/00

(52) U.S. Cl. 705/36 R

(57) ABSTRACT

The invention is a method of survey wherein the preferred embodiment is by electronic computer systems, allowing the respondents to respond to surveys of prohibited stock, funds, outside employment, spouse's employment, honoraria, outside agreements, arrangements, gifts, travel, and reimbursement. Before the invention, respondents had to manually fill out disclosure forms by hand. If they made errors, a reviewer had to read over every filled out disclosure form, then send it back to employee and have them correct it. The respondent would have to fill the form out all over again and send it in again. The amount of hours of wasted time to do this is over thousands of hours. The program invention computerizes the form, protects from mistakes, allows preview before print, either allows or disallows prohibited stocks, and allows respondents' to save the form on computer discs to email, or upload, as well as save for the next year so respondents do not have to re-fill out the portions of the survey which have not changed, such as name, and perhaps title, address, phone, stock investments, etc.

Pursuant to 37 CFR 1.71(e): A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCES TO RELATED APPLICATIONS (IF ANY.)

None

### STATEMENT AS TO RIGHTS TO INVENTIONS MADE UNDER FEDERALLY-SPONSORED RESEARCH AND Development

None

References in parenthesis in the specification are to sources appended at the end.

### BACKGROUND OF THE INVENTION

1. Field of the Invention

The present invention is directed to using and testing devices or compounds which allow SURVEY devices TO REDUCE PREPARATION and REVIEW COSTS and SAVE TIME to COMPILE, RECORD AND REVIEW as well as many other applications.

2. Description of the Prior Art

Monetary Management Surveys have generally dealt with return on investment. Most authors consider the profit motive of prime importance. Similarly, Surveys have focused on opinions about investments, rather than the ability of investments to influence opinions. Thus, neither financial data collections nor consumer research has related monetary management with preservation of integrity in the business place.

### 2A. BACKGROUND OF THE INVENTION

### Surveys, Information and Data collection, reporting and reviewing

Communication has always been necessary. So has information. Surveys are a form of collecting and communicating information. Whether the information is used to manage people, animals, weather, money, equipment, or property, is a factor in how the survey is prepared. What is desired? Who is queried? How is the information collected? How is it compiled? Is it summarized? When is the information obtained? Who will review the information? Where will the information be stored? How will it be retrieved? Can the information be evaluated? Is it useful? Is it worthless? Sometime surveys are called data collection, or information retrieval. The history of surveys demonstrates some answers to these questions.

### 2B. BACKGROUND

### Surveys in History—Inventory of Animals and Plants Calendars. Families

About the Fourth millennium before Christ, the Bible began a collection of writings of the prophets and scribes, by collecting laws and information on the people.

Adam named animals as recorded Genesis 2: 20. “And Adam gave names to all cattle, and to the fowl of the air, and to every beast of the field.” This is the first recorded survey by which data could be later collected and evaluated. Why give names to the cattle, beasts, and fowls? Seemed like a good idea. With names, their usefulness could be recorded and retrieved. What animals were useful for transportation? Not the gold fish, or Eagle, but the horse, camel, ass, and ox. What animals are useful for food? Perhaps all could be killed, cooked, and eaten for protein, but the most useful would be animals which produced food on a regular basis, such as eggs from chickens, milk from goats and cows, and honey from bees. What animals were dangerous? On a scale of one to ten, of least dangerous to most dangerous, the cobra and lion and tiger would be a two digit rating, while the rabbit or dove would rate a one. What animals were useful for clothing? Not the jelly fish. While its possible all animals with skins could qualify, if one had thread and needle, the most useful would be animals who could produce clothing, or its parts, on a regular basis, such as wool from sheep and goats, and silk from worms, without destroying the animal. This reminds us of the fairy tale of the goose that laid the golden eggs, and how when the owner was hungry, the goose became a fine Thanksgiving meal, which ended the egg laying. Which animals would be shelter? Animal skins could make tents, but wood and stone is superior. And so forth, the survey provided a basis for data recording and retrieval.

Surveying has been closely associated with counting. How much? How often? And thus Genesis chapter One counts days, the first to the seventh, when God ended his work and rested. Genesis 2:2. This seven day cycle presumably became the basis for the week.

Somewhere the concept of time and year became understood, for by Genesis 5:3 we learn that Adam lived an hundred and thirty years, begat Seth, and by verse 5, Adam lived nine hundred and thirty years and died. Thus the survey of time and age becomes a useful concept, as needs, abilities, wants, desires, are often related to age.

At least by the third millennium before Christ, the concept of distance was introduced. In Genesis 6: 15, Noah makes an ark whose length is three hundred cubits, and whose breadth is fifty cubits. Was the ark the first boat? We don't know, but we know that a floating house has a name, and its length and breadth have measurable units assigned with numbers. It even has a first, second and third story (Genesis 7:16). Next concept is an inventory as animals are assigned two of every sort as male and female (verse 19) to keep them alive, and seven of clean beasts (Chapter 7, verse 2). The calendar is further revealed as the trip, and rain begin on the six hundredth year of Noah's life, second month, seventeenth day, at least according to Chapter 7 verse 11. Thus we have length, breadth, inventory, months and years. A passenger and crew manifest is recorded at verse 13, listing four men and four wives, for a total of eight. Which information could be retrieved, studied, and analyzed, as it was three millennia later by Peter who states (1 Peter 3:20. “Which sometime were disobedient, when once the long suffering of God waited in the days of Noah, while the ark was a preparing, wherein few, that is, eight souls were saved by water.” We get the number 8. The record is silent as to when the counting began, but it was established enough to keep track of time and talent.

The Bible record begins to count, and list, and inventory. Chapter Ten lists the generations of the sons of Noah, or Noah's descendants. Names of places are offered with the names of people, so the chapter becomes an early day address directory. And along with addresses, the concept of ownership must have accrued.

About second millennium before Christ, Genesis Chapter 11 lists more generations, and ages, leading toward a hero by the name of Abram, later called Abraham. Gen. Chapter 14 inventories Kings and their wars, and the times of their service. Along with the raids of war was the note “they took all the goods” (Gen. Chapter 14:11). Abram had his own census of armed trained servants, “born in his own house, three hundred and eighteen” (Genesis 14:14). Abram's army pursues and overtakes the raiders, and retrieves his nephew, the women, and the goods. Abram paid a tithe (tenth) to King Melchizedek of Salem (Gen. 14:18), which reference may be the earliest recorded rate assessment schedule. Apparently, keeping track of persons and property is an ancient custom. The stories unfold with more numbers, “twelve princes” (Gen. 17:20), “ninety years old and nine” (Gen. 17: 24), “three men” (Gen. 18:2), “fifty righteous” (Gen. 18:24), “forty” (Gen. 18:29), “thirty” (Gen. 18:30), “twenty” (Gen. 18:31), “ten” (Gen. 18:32). Someone is keeping track of all these princes, years, and righteous. This is the survey.

Abraham's grandson was named Jacob, later called Israel. His family's story takes up nearly the last half of Genesis. Israel's story includes a migration of Seventy (Exodus 1:5) family members from Canaan into Egypt. This is an early immigration census. The number of 70 was repeated as Ahab had 70 sons (2 Kings 10: 1), the Israelites served the King of Babylon 70 years (Jeremiah 25:11), the Lord directed that seventy weeks be the time for the people of Jerusalem to end transgression and sin (Daniel 10:24), and the Lord, Jesus Christ, appointed 70 missionaries (Luke 10:1).

Perhaps Eighteen centuries before Christ. Jacob, Israel's, sons divide into twelve tribes (Exodus 1:1-5), which became a means for civilization management for a thousand years.

Perhaps fourteen centuries before Christ. After four centuries, Moses became the leader, and conducted a census, which was detailed in the book of Numbers. “Take ye the sum of all the congregation of the children of Israel, after their families, by the house of their fathers, with the number of their names, every male by their polls; from twenty years old and upward, all that are able to go forth to war in Israel . . . ” (Numbers 1:2-3). Thus were soldiers, adult males able to go forth to war, named and counted, in the house of their fathers (Numbers 1:30)

Joshua becomes prophet, general, and leader after Moses. His book included a written geography and political directory of the maps, cities, plains, coasts, rivers, and Kings in the land (Joshua 12). This gives another use of surveys for recording and tracking political alliances and possessions.

About the first millennium before Christ, David was King of Judea. Beginning about his reign and as recorded for several more centuries, one of the Bible books, First Chronicles, is given over almost entirely to an inventory of families, names, census, cities, and lineage of the Houses of Israel. These covered topics such as “four and forty thousand seven hundred and threescore, that went out to war” (1 Chronicles 5:18), “of their camels fifty thousand, and of sheep two hundred and fifty thousand and of asses two thousand, and of men an hundred thousand . . . ” (1 Chronicles 5:21), “for lifting up his spear against three hundred, he slew them” (1 Chronicles 11:20), “6,800 ready armed to the war” (1 Chronicles 12:24), “7,100” “3,700” “3,000” “22” “18,000” “20,800” “200” “50,000” “37,000” “28,600” “120,000” (1 Chronicles 12:25-37). These counted people. Surveys also counted size, as recorded that Goliath of Gath's “height was six cubits and a span” (1 Sam. 17:4), or weight, wherein the “weight of the coat was five thousand shekels of brass” (1 Sam. 17:5), and “spear's head weighed six hundred shekels” (I Sam. 17:7). Before Goliath's defeat, presumably King Saul asked the men of Israel “Have ye seen this man? . . . [which warrior wants] great riches, and . . . [the King's] daughter, and make his father's house free in Israel?” (1 Sam. 17:25). This reward was a survey, asking to be accepted. The survey was mouthed among the troops.

About the sixth century before Christ, the Greeks began the Olympics, which were tests of military skills, with rewards, held about 6th century B.C. to 4th century A.D. Every four years. The Olympics were so significant, that the Greek calendar reckoned events from the number of the Olympiad.

By the meridian of time, we have had surveys for military strength, inventories for food, sports contests for entertainment and skills development, tithing for religious worship, inventories for transportation, immigration, geography, and political control.

The Anglo-Saxon chronicles, begun under Alfred the Great, and retrieving records from the invasion of Britain by the Saxons and Angles at the end of the fifth century, has the political and religious survey of the era.

By the Second millennium after Christ. The English crown and Parliament commissioned the visits of Heralds. Heralds were representatives of the government who went to the Shires and estates throughout England. These visitations, through the land, were during Henry the Eighth's reign about 1537, then during Elizabeth the First, then a few generations later during James the First about 1615, and after the Restoration in 1664. The Heralds requested each family, claiming arms, to prove their right to armorial bearing, that is the shield or crest used to show lineage and prestige. This survey was taken to the people. It took years to complete and report.

### 2C. BACKGROUND OF THE INVENTION

### The United States

By the end of the Second Millennium A.D. surveys have become ubiquitous, to inform, solve, record, measure, compose, design, entertain, explain and plan. Until the electronic computation was invented, all written surveys were completed by hand. The personal computer allowed an advance in the completion, and an increase in efficiency by reducing errors, and permitting better retrieval and recordation.

By 1790, the first U.S. Census was conducted, to establish the proportion of representation in Congress, based on population. This American census has been repeated every 10 years, since.

The Northwest ordinance, circa 1777, was used to begin and surveys of the territories around the great lakes.

By the twentieth century, businesses and advertisers created consumer surveys. Buyers were asked what they wanted, and why. These were sponsored by manufactures to generate sales and reduce losses.

Another name for surveys are test marketing. Create a product and see if there is a demand. Sometimes, two or three towns in the nation will be chosen, and local advertising will introduce the product or service to see if it takes off. If it succeeds, then it is duplicated in other markets. If it fails, it is never more heard from.

Clinical trials are surveys for medical products, drugs, devices, used to determine if they work, help, or hurt. They are now required by the Food and Drug administration, and were performed as early as the 18th century.

College tests are surveys of intelligence and relative performance. The rewards are grades and recognition. The students come together before test givers at the same time, to compete. Once graded by hand, they are now usually machine graded.

Horse races are surveys for gambling and entertainment. They survey the skill of pony and jockey. When horses were the primary means for transportation the game of polo offered recreation to test military skills. Test and surveys. Data and information. All used by managers for gathering wealth, or making assignments.

Modern sports contests, more elaborate than the ancient Grecian Olympics survey the skills of athletes. This too has developed into business production for entertainment. Games include football, baseball, basketball, boxing, wrestling, hockey, racing, soccer, gymnastics, and other sports. Marathons included tens of thousands of runners competing at the same time, same location, same temperature, same weather condition, just as in a war. Success in these surveys suggest ways to modify or improve training, diet, mental preparation, or clothing.

The modern Olympics, modern since 1896, are held every 4 or 2 years, for winter or summer sports. They provide events for TV and other broadcast means around the world. These surveys bring many of the best competitors, if not every one, together for the events.

Beauty pageants are surveys of persons competing for prizes. The events are to entertain and bring recognition, so that advertisers will support the pageants.

Marksmanship are surveys to measure military skills, either with bow and arrow, or rifle.

Political surveys are questions among voters or supporters or opponents to measure weakness, or strength, before, during or after an election or community decision making event. The information can be obtained by telephone, in person, or mail. The data is analyzed so as to direct advertising, to spend money, to improve influence.

Patents and copyrights are collections of surveys of intellectual property. Their purpose is to preserve rights and ownership, to collect data and categorize it. The purpose is retrieval.

Libraries are collections or surveys of writing and communication. They may be described as existing in the flat medium, meaning paper, film, disks, and photos, items which generally exist in three dimensions. In contrast, museums are collections of surveys of three dimensional media.

Almanacs were collections of calendars used to record temperature, rain fall, and sun light, usually year around. They had real use for farmers, to know when to plant or sow, harvest or reap. They were based on calendars giving days, weeks, and months, winter and summer solstice, spring and autumnal equinox. As the data collects, so that many reading are available, a better understanding of ranges, and averages are available.

Dictionaries are surveys of words. Languages are the codes of society, and now the codes for computers. Surveys of cross languages or bilingual collections are used to translate information. Books surveying synonyms, antonyms, and cross word puzzles, are available.

A survey in 2003 found that half those surveyed at the Air Force academy had heard religious slurs and jokes. (New York Times, Air Force Cadets See Religious Harassment, by the Associated Press. Apr. 20, 2005).

Since 1980, several inventors have designed surveys to increase efficiency, increase speed, reduce awkward positions, reduce cramping, avoid slow down, reduce errors, and reduce fatigue.

### 2D. BACKGROUND OF THE INVENTION

### Science Meets the Survey

I. Technology.

Surveys can be used for new science and technology. About 1955, after the news became common about the jets flying above Mach One, some in the U.S. Government were concerned about the effects of sonic booms on people, buildings and animals. The Government selected 3 cities in which a sonic boom test would be conducted, wherein military planes would fly over, break the sound barrier, and report damage. Indeed some claimed injury to person and property. Claims would be processed and analyzed. Experiments indicated that sonic boom over pressure, if close enough, could crack concrete. However, if the flights were miles high in the sky, would booms be a hazard? The first flights were scheduled in Oklahoma City. The flights would be announced for the morning and afternoon and twice a day the booms would sound. This went on for months. The result was satisfactory enough, that the other two cities' tests were waived. The tests, or surveys, were conducted every morning and afternoon, sometimes seeing the plane, but noticing thunder under blue skies, bright sunshine, mid day. No clouds. No rain. This was a science survey in which only complainers would bother to report.

By the late 1990s, the personal computer became a means to obtain information on many many millions of people. Not just where they live, but, by using cookies, and spy ware, what they looked at, web sites they visited, ads they responded to, and many more details could be added to a data base. With the information specific advertisements can be offered. Extra bait can be offered to encourage spending. More information can be provided to persuade opinions. Every thing that is obtained by the internet can be identified for specific patterns. The computer provided the convenience of the person making input to remain at work or home, without traveling to a central location as in the days of Joseph or the high school senior taking college application tests. The computer provided means for convenient review and maintain a general, and if desired, permanent record. Computer data entry was superior to the hand written survey which was not conveniently retrievable.

Monetary Management refers to the inventory and understanding of investments and how they influence actions. Psychologists suggest that some investors chase losses by buying more of a losing investment, sell their gains too soon, let their losses run, and perhaps favor the companies with which they have investments. This last issue is a question of influence on judgment. As it is subjective, the approach is usually to avoid the risk of making bad judgments, by not participating in investments which are likely to create the judgment. In short, avoid self dealing.

The computer is a good way to reduce waste and labor in all stages of completing survey: design, listing questions, completing or responding to questions, advancing to different categories of questions, updating answers, amending answers, checking for errors, storing, retrieving, reporting, recording, reviewing, analyzing responses, and updating surveys.

ii.a. Financial Surveys: Ancient.

Perhaps the most famous financial survey ever was the census which Caesar Augustus decreed when all the world would be taxed. That is all the non-Roman world, because the Roman citizens were exempt from paying taxation or tribute (although they paid gifts and offerings) Luke records this as Chapter 2, verse 1. The taxation return required that each adult male, head of household, return to his home, in the case of Joseph it was Bethlehem (Luke 2:4), to declare his property. This was mostly inefficient as the Bible records that Joseph had to leave his business in Galilee of Nazareth, and hike several weeks to arrive at Bethlehem. Apparently many others had to do likewise, for Joseph and Mary sought lodging, but “there was no room for them in the inn.” (Luke 2:7). This cannot have been very efficient.

By the end of the first millennium after Christ, William the First, the Conqueror, King of England directed that a land survey be compiled, which was called the Domesday book. It gave the rulers an inventory of land in England, with ownership, making the taxing and economic matters of import and export, more understandable. The survey was on-site, that is at the location of the property, in the Shires around England.

Within two hundred years, circa 1190, William's descendant, King Richard, the Lion Hearted, was captured in Austria, while returning from the Crusades. The Austrian noblemen realized this opportunity to demand a true King's ransom for his hostage, and may have priced the ransom at three times the gross national product of England. It was paid. Somebody had to raise it.

ii.b. Financial Surveys: Modern.

Colonial to modern American towns, eventually, in similitude to the Domesday book, used real and personal property as the basis for local taxation. Therefore valuations are conducted on occasional events, sometimes when property sells, and sometimes every 5 to 10 years. This allowed the local government to decide its budget, calculate how much money needed to be raised against how much property value was available, divide the numbers and levy the taxes. These are monetary surveys.

The American tax return, just as in the days of Caesar, are a money survey to raise revenue for the government. The returns are done locally and submitted nationally for review and analysis. Wrong returns may be challenged. Returns cover income, estate, franchise, corporate, franchise, and other taxes.

iii. Monetary Management Conditions.

Financial markets provide and exist for surveys of transactions. The sale or purchase of stocks, bonds, commodities, depends on and sustains the reporting. This is all about money, wherein information is power.

Monetary Management surveys are used to measure influence. If made by a company, it may be to determine the loyalties of the employee. If by a government, it may be to see if a conflict of ethics is created by having financial incentives for making decisions one way or another.

Users, both respondents, and reviewers, will be helped by the invention in reducing time to complete surveys, reducing cost to complete surveys, as compared to paper completions. Besides observing that most surveys are reviewed away from the respondent, the reviewer must have a means to record the data, retrieve it and analyze it.

### 3. OBJECTS OF THE INVENTION

(1) It is an object of the present invention to provide a method for surveys to control or reduce the cost of obtaining information,

Another object of the invention is to establish a method for surveys to control or reduce and (2) the difficulty in obtaining useful information.

Another object of the invention is to establish a method for surveys to obtain the most efficient amount of information, for if (3) the amount of information is too much, it clogs review because it includes that which is not relevant—relevant meaning that which is pertinent, related or applicable.

Another object of the invention is to establish a method for discarding wrong information which is useless in that (4) answers which are erroneous or not material—material meaning that which is essential, grind down the review.

Another object of the invention is to establish a method for improving quality of (5) those responding to surveys are who are not competent, either because of ignorance or lack of training.

Another object of the invention is to establish a method for identifying the ideal survey which will be (6) literate, meaning containing instructions for learning.

Another object of the invention is to establish a method to (7) communicate—communicate meaning impart or share information.

Another object of the invention is to establish a method for assuring data is (8) retrievable—that is to recover, restore, or regain.

Another object of the invention is to establish a method for making the survey (9) efficient—that is producing effects or results, or being powerful and ready.

Another object of the invention is to establish a method for the survey being ready in that it is (10) timely, that is opportune, occurring in a duration or in the proper season.

Another object of the invention is to establish a method for surveys to be able to organize the data into (11) summaries—that is abridgments or compendiums. This means the invention is scalable, can decrease in size.

Another object of the invention is to establish a method for surveys to be able to organize the date into (12) expansive volumes—that is to increase in size, dilate, or extend. This means the invention is scalable, can increase in size.

Another object of the invention is to establish a method for the form of the survey to include (13) lists of questions, in words searching for discussion and information.

Another object of the invention is to establish a method for increasing participation percentage, because intuitively the ratio of success is inversely proportional to the (14) time consumed in responding, that is the less time a respondent is required to invest in the survey, the more likely or greater the response.

Another object of the invention is to establish a method for the means by which the survey is obtained or stored, so that the method may control the ease for (15) data retrieval, for correction by the respondent, or for review by the researcher.

Another object of the invention is to establish a method for (16) electronic data storage, which has some advantages in space and convenience over paper storage.

Another object of the invention is to establish a method for by which if the survey anticipates the use of the data, it can prepare ahead of time, the organization of the date for (17) data manipulation, that is combining and recombining the information for comparisons and review for trends.

Another object of the invention is to establish a method for considering that the cost of the survey will be often related to (18) time consumed in reporting, and if the respondent is being paid to complete the survey, (such as by an employee completing a form on the job), this can be significant. Time for completion is of less concern when the researcher does not have any responsibility toward the respondent (i.e. such as tax returns, or college application tests).

Another object of the invention is to establish a method for the researcher to be aware of the (19) time in reviewing survey responses, especially if accuracy is a goal.

Another object of the invention is to establish a method for reviews if they require substantial (20) time in changing answers or responses, or these required changes may defeat the purpose of the survey.

Another object of the invention is to establish a method for the survey to consider the (21) time in repeating and correcting answers.

Another object of the invention is to establish a method for surveys monitoring financial interests, relative to responsibility, in order to focus on (22) changes which improve efficiency and lowers cost of completion and review.

### SUMMARY OF THE INVENTION

In accordance with the foregoing objectives, there is provided a summary of Monetary Management Program:

Data entry: This program conveniently guides the person along each path of the flow chart. The flow chart permits the person to answer online question, to correct mistakes, and to provide sufficient information, hopefully during the initial contact. This is economical, fast, and reduces or eliminates the need for later corrections. The number of questions can be expanded as needed, and passed over if not applicable.

Because the flow chart and the answers are on line, or electronically generated, changes, over period of time or years are enabled. This reduces volume storage, and makes additions more efficient, and allows time sensitive responses.

A virtual copy of the program may also be preserved electronically by disk media. If the person requires additional time to research answers, perform other tasks, leave the program, or answer other interruption, the information and data entered can be preserved for later retrieval and modification. The person opens the preserved program and data and extends the answers, modifies previous entries, or takes whatever additional steps needed to complete the task. It is convenient for the data to be transmitted by mail (disk), carriage (disk) or by telecommunications (internet, modern, broadcast, radio, satellite).

Uploads and downloads are available.

Analysis of Data. As with any electronic entry, copies are more easily accessible by those requiring to understand, comment, approve, or deny the results of the data entry.

Once the data has been entered, in an employment situation, the employer can manipulate or evaluate the data. In a design situation, other designers can test and comment on the data. Any requirement for evaluation is more efficient, cheaper, and faster than preserving data only in a fixed medium, i.e. print on paper.

The data requests can be expanded to accommodate information. For money management, any pooled resource investment funds (mutual funds, pensions, statutory accounts, etc), can be included for identification, by address and any reliable value means. Data can be required in as great a degree of specificity as desired, from the generic “money” to company names, account numbers, addresses, contacts, etc.

If desired, the flow chart can be sequential, requiring completion in a specific order, or it can be randomly accessed, starting in the middle, end or any place. This is flexible, and is convenient for the person to provide information that is available, reserving completion until all data is available.

Ultimately a positive answer must be provided for all questions in the flow of the survey in order to complete the survey. Partial answers are inadequate, so a Yes or No must be provided for every category of monetary assessment, such as Obligations and debts, Compensation received from others, contractual situations, donations received, In kind additions, tickets, lodging, food, clothes, car, train, plane, receipts, adornment, honors, other benefits, etc. Everything must be answered, and if positive, described, above what ever predetermined amount, whether $2 or $20,000, or any other amount.

The flow chart and program can be enabled to search for terms, select doubtful investments, or activities that are to be avoided. Once an investment is flagged for removal, a letter or other communication can be generated to the person advising of the need for changing the basis for the financial matter. This might be to sell or give away investments, stocks, to pay down or pay off bills, debts, etc.

### BRIEF DESCRIPTION OF THE DRAWINGS

FIG. 1 illustrates the flow chart including data on survey. FIG. 1 shows the filers required to submit OGE-450 via the MMA Application.

FIG. 2 also indicates a flow chart showing the filers required to submit OGE-450 via the MMA Application.

FIG. 3 describes the data entry process for filers starting the MMA Application.

FIG. 4 describes how filers review and submit the OGE-450 data.

FIG. 5 shows the final submission of the OGE-450 data via the MMA web application.

### DESCRIPTION OF THE PREFERRED EMBODIMENT

Survey and Flow chart, and critical path.

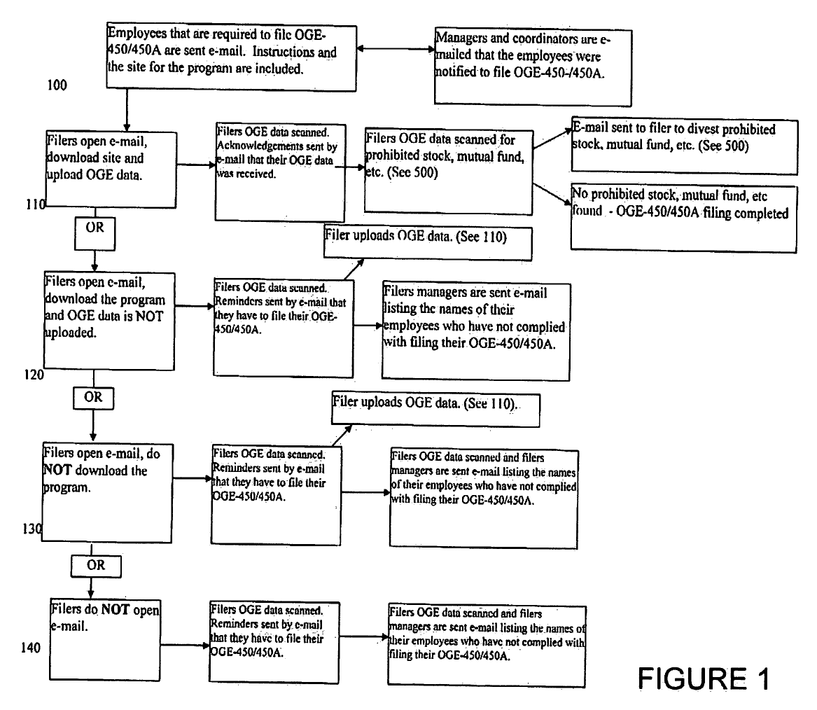

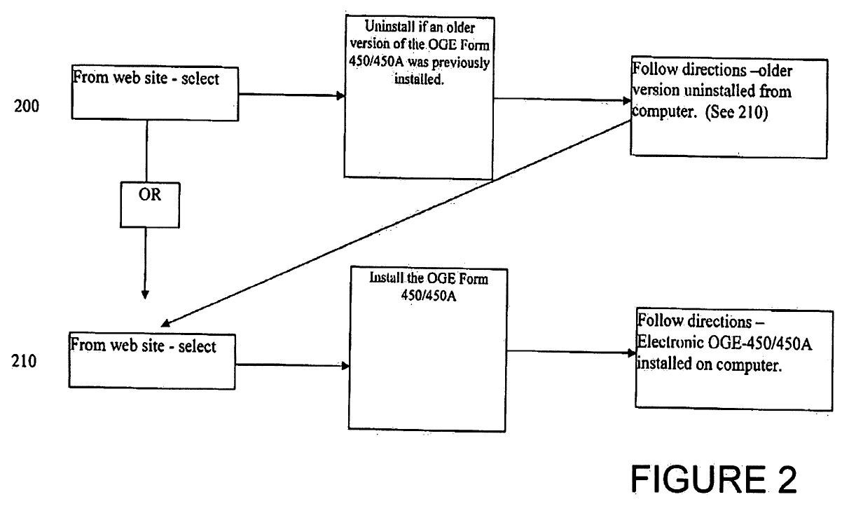

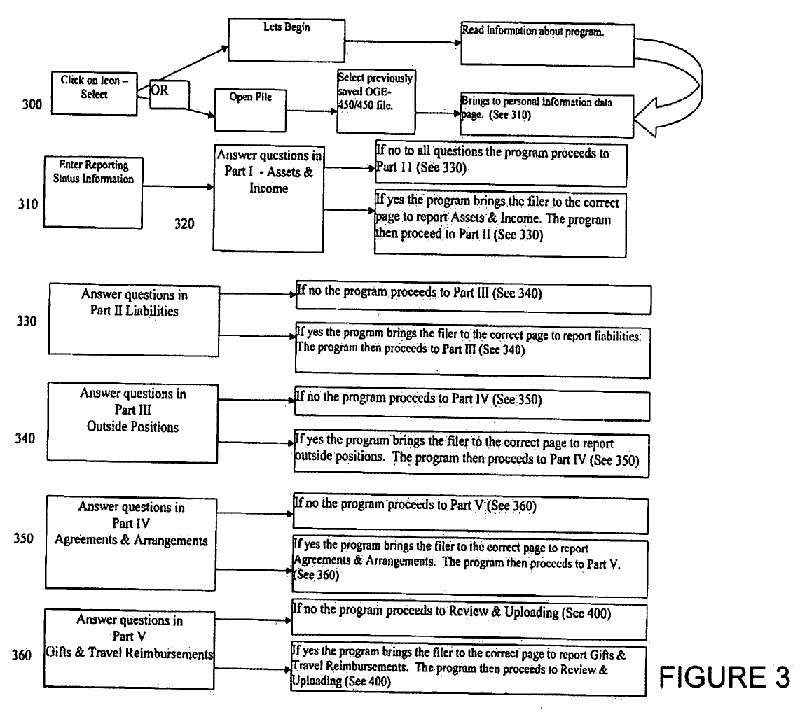

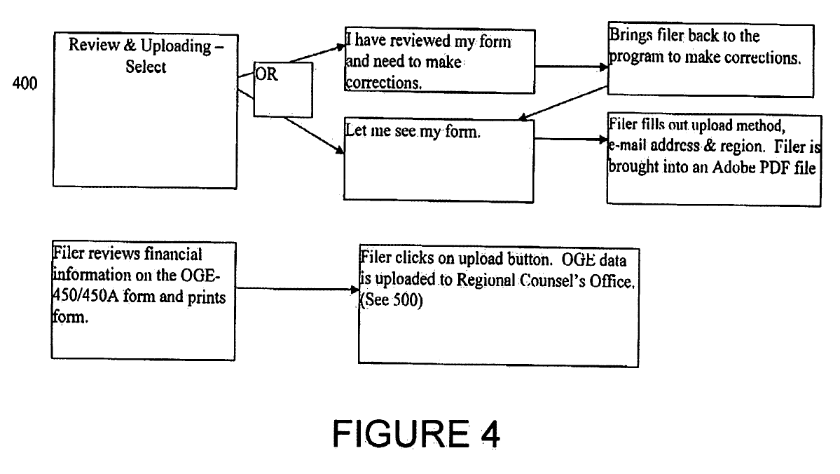

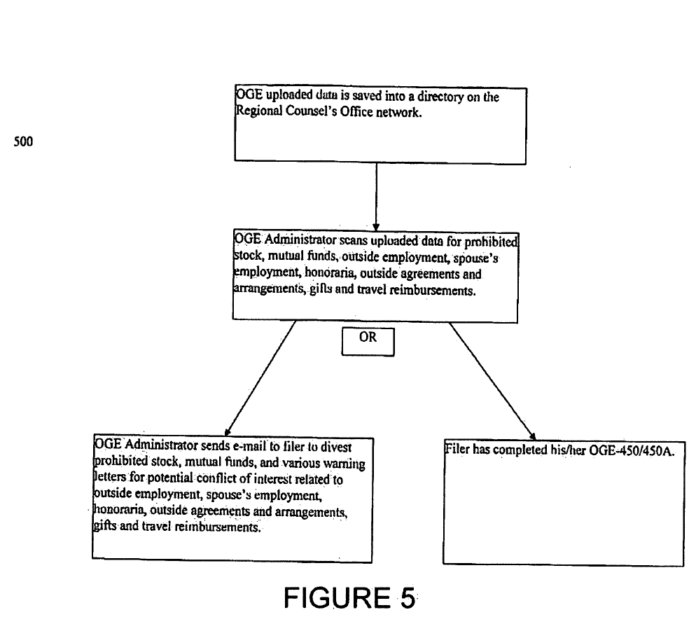

FIGS. 1 through 5 describe the invention using a series of flow charts, as described below.

Summary Survey:

100 Does respondent get an email advising of need to complete survey? Yes, No.

200 If yes at 100. Respondent downloads survey.

300 Is Data Entry survey available? Yes, No.

400 Help information

500 Employer's email letters to respondent to advise on monetary management, to divest stocks, funds, with conflict of interest on outside employment, outside agreements, gifts, honoraria and travel reimbursements.

Expanded Survey:

100 Respondent email advising of need to survey, copy to employer. Go to 110.

110 Respondent open site, data scanned for stock, if prohibited send letter, if not close. Go to 200.

120 Respondent's don't respond, more reminders sent. Copy to employer. Go to 100

130 Respondent's don't respond, reminded. Go to 100.

140 Respondent's don't respond, employer's advised. Go to 100

200 Respondent's select survey, follow direction for completion.

210 Respondent's select survey web site, follow direction for completion. Go to 300.

300 Respondent's survey. If new file, selects beginning, opens file, reads information. Respondent's survey. If returning to file, open, retrieve, add information. Go to 310.

310 Respondent reports status on assets and income. If yes, go to 320. If no, go to 330.

320 Respondent reports assets and income. If yes, respondent advances (go) to 325.

325 Respondent reports assets and income. Go to 330.

330 Respondent reports liabilities. If yes, go to 335. If none, go to 340.

335 Respondent reports liabilities. Go to 340.

340 Respondent reports outside Positions. If yes, go to 345. If no, go to 350.

345 Respondent reports outside Positions. Go to 350.

350 Respondent reports agreements and arrangements. If yes, go to 355. If no, go to 360.

355 Respondent reports agreements and arrangements. Go to 360.

360 Respondent reviews—asked for corrections, amendments. If yes, go to 365. If no, go to 400.

365 Respondent reviews and returns to 325, 335, 345, or 355.

400 Respondent reviews If satisfied, go to 410. If not, return to 360.

410 Respondent uploads. Copy sent to employer. Go to 500.

500 Survey data saved to directory for employer. Go to 510.

510 Survey data scanned for prohibited stock, funds, outside employment, spouse's employment, honoraria, outside agreements, arrangements, gifts, travel, reimbursement.

If problem Go to 520. In no prohibited monetary management, go to 530.

520 Employer advises respondent for action. If yes, go to 525. If none taken, go to 510.

525 Respondent acts.

530 Respondent completes monetary management action and saves report until next reporting period.

By presenting “either/or” questions, the program can select the appropriate question to answer. It works with Adobe program, and not MS word. A flow chart is a logical path which selects from several alternatives to guide the person to a decision. In this case, the decision is whether the survey taker will take additional action, in keeping ethics or disposing of property or other actions consistent with the goal of the survey.

Uses for the program, survey of patients involved in taking multiple medicines, each which interacts with the other.

Survey for selecting education based on the cost, or experience, or location of the training.

The calculations depend on the dates of the information, such as partial month or year survey reporting.

The program converts logic path selection into electronic visual responses. This has been done in teaching, such as chemistry or physics, or math, and the responses match the predetermined solutions; but this is open to cross check for conflicts—those investments in companies which have dealings with the respondent's office, and by which the judgment of the respondent could have influence on the financial decision. What are the conflicts software available to experts? How thorough can the programs be made?

List all the clients and years, or amounts, or relevant information. What are sizes of flow chart programs?

A. Purpose of the Invention

The purpose of the invention is to manage monetary affairs.

This is accomplished in a these steps.

1. Set Goals and Procedures: An individual answering a survey is giving a response, therefore they are called the respondent.

2. Log on by respondent. The survey notifies respondent; acknowledges receipt of form; reminds to file form and sends memo to employer that respondent has not submitted form.

3. Obtain name list of respondents from the offices.

4. Identify software Requirements: Lotus Notes & equipment.

5. Register at web site. Where respondent's work stations cannot open the web site, designate a general location where respondents will open web site.

6. Identify responsible employers by e-mail, or establish a discussion group. The purpose is to maintain and update a list of respondents as required. The employer will return and report.

7. Select responsible employers with e-mail address list.

8. Train Presenters.

9. Publicize the internet Location

10. Receive data at a central electronic address.

11. Separate website so users can upload files with one click of a button. Reply with date received and data recorded.

12. Store data. Require a user ID and password accessible.

13. The Monetary affairs management person selects name Identification and password. A web manager supports the user ID and password.

14. Designate a contact for unknown password (lost, forgotten)

15. Designate a contact to include/remove a new user.

16. Store Data in one or multiple locations.

17. Answer employer or employee concerns.

18. Meet and discuss.

19. Employers' provide respondents' names and notify each respondent of the filing requirements.

20. Employers' follow through with reminders when filing is overdue.

21. Respondents correct when filing is inadequate.

22. Experts in IP meet with employers and respondents on status of survey and software.

Requirements: Adobe 6.0 Travel Manager. Adobe has penetrated over 95% of the Personal Computers in America.

23. The Employer enables software as required and confirms the computers are Pass & ID capable.

24. Contact Respondents' Employers when the response is overdue, insufficient, or in error.

B. Survey Advancement Accomplished by this Program.

Before this program invention, respondents had to manually fill out disclosure forms by hand. If they made errors, a reviewer had to read over every filled out disclosure form, then send it back to respondent to correct it. The respondent would have to fill the form out all over again and send it in again. The amount of hours of wasted time to do this is over thousands of hours.

The program invention computerizes the form, protects from mistakes, allows preview before print, either allows or disallows prohibited stocks, and allows respondents' to save the form on computer discs to email, or upload, as well as save for the next year so respondents do not have to re-fill out the portions of the survey which have not changed, such as name, and perhaps title, address, phone, stock investments, etc.

### REFERENCES CITED IN SPECIFICATION

1. Bible.
2. Internal Revenue Code.

What is claimed is:

1. A method for surveying the inventory of assets, liabilities, obligations, agreements, situations, and contracts, the method comprising the steps of:
providing the respondent with a survey,
instructing the respondent on the proper use of the survey, as determined by the manufacturer or creator,
establishing a base line data for the respondent,
monitoring the respondent so the report is consistent with the instructions,
recording answers and responses,
measuring changes in the respondent's assets and income, against the base line data,
measuring changes in the respondent's liabilities, against the base line data,
measuring changes in the respondent's employment, against the base line data,
measuring changes in the respondent's agreements and arrangements, against the base line data,
measuring changes in the respondent's spouse's employment, against the base line data,
measuring changes in the respondent's gifts, against the base line data,
measuring changes in the respondent's travel, against the base line data,
measuring changes in the respondent's reimbursements, against the base line data,
measuring changes in the respondent's circumstances, against the base line data,
comparing the results of monitoring use and measuring changes to determine a preferred data,
allow or disallow prohibited stocks, bonds, mutual fund, investments, obligations, oaths, contracts or agreements,
reviewing, recording and analyzing results for preferred action
advising respondent of required action, if any,
repeating all steps on periodic basis.

2. The method according to claim 1 wherein a survey includes electronic devices, which record data without the necessity of pen, ink, or pencil, which electronic device changes can be calculated by electronic or mechanical devices.

3. A method for surveying, following a flow chart logical progression which prevents completion of entire form until all questions have been answered.

4. The method according to claim 1, wherein the method includes Adobe Acrobat program.

5. The method according to claim 3, wherein the flow chart logical progression includes one or more of the following steps.
Summary Survey:
100. Does respondent get an email advising of need to complete survey? Yes, No.
200. If yes at 100. Respondent downloads survey.
300. Is Data Entry survey available? Yes, No.
400. Help information.
500. Employer's email letters to respondent to advise on monetary management, to divest stocks, funds, with conflict of interest on outside employment, outside agreements, gifts, honoraria and travel reimbursements.
Expanded survey:
100. Respondent email advising of need to survey, copy to employer. Go to 110.
110. Respondent open site, data scanned for stock, if prohibited send letter, if not close. Go to 200.
120. Respondent's don't respond, more reminders sent. Copy to employer. Go to 100
130 Respondent's don't respond, reminded. Go to 100.
140. Respondent's don't respond, employer's advised. Go to 100
200 Respondent's select survey, follow direction for completion.
210. Respondent's select survey web site, follow direction for completion. Go to 300.
300. Respondent's survey. If new file, selects beginning, opens file, reads information. Respondent's survey. If returning to file, open, retrieve, add information. Go to 310.
310. Respondent reports status on assets and income. If yes, go to 320. If no, go to 330.
320. Respondent reports assets and income. If yes, respondent advances (go) to 325.
325. Respondent reports assets and income. Go to 330.
330. Respondent reports liabilities. If yes, go to 335. If none, go to 340.
335. Respondent reports liabilities. Go to 340.
340. Respondent reports outside Positions. If yes, go to 345. If no, go to 350.
345. Respondent reports outside Positions. Go to 350.
350. Respondent reports agreements and arrangements. If yes, go to 355. If no, go to 360.
355. Respondent reports agreements and arrangements. Go to 360.
360. Respondent reviews—asked for corrections, amendments. If yes, go to 365. If no, go to 400.
365. Respondent reviews and returns to 325, 335, 345, or 355.
400. Respondent reviews If satisfied, go to 410. If not, return to 360.
410. Respondent uploads. Copy sent to employer. Go to 500.
500. Survey data saved to directory for employer. Go to 510.
510. Survey data scanned for prohibited stock, funds, outside employment, spouse's employment, honoraria, outside agreements, arrangements, gifts, travel, reimbursement. If problem Go to 520. In no prohibited monetary management, go to 530.
520. Employer advises respondent for action. If yes, go to 525. If none taken, go to 510.
525. Respondent acts.
530. Respondent completes monetary management action and saves report until next reporting period.

6. The method according to claim 1, wherein the purpose for collecting the survey data is monetary management.

7. The method according to claim 1, wherein the review program converts logic path selection into electronic visual responses.

8. The method according to claim 1 wherein the method comprises a further step of comparing responses to predetermined solutions.

9. The method according to claim 1 wherein the method comprises a further step of a survey of cross checks for conflicts—those investments in companies which have dealings with the respondent's office.

10. The method according to claim 1 wherein the method comprises a further step of determining judgment of the respondent could have influence on the financial decision.

11. The method according to claim 1 wherein establishing the base line data includes the ID and password of the respondent for security.

12. The method according to claim 1 wherein the method comprises a further step of Employer enables software as required and confirms the computers are Pass & ID capable.

13. The method according to claim 1 wherein monitoring includes performance amount of work and time required by the respondent.

14. The method according to claim 1 wherein the method comprises a further step of notifying creator, manufacturer, or employer that the response is overdue, insufficient, or in error.

15. A computer program which combines all the methods according to claim 1.

16. The method according to claim 1 wherein the method comprises a further step of protects from mistakes.

17. The method according to claim 1 wherein the method comprises a further step to allows preview before print.

18. The method according to claim 1 wherein the respondent may be an individual, company, trust, partnership, business, corporation, government, office, groups, associations, or anything capable of exercising free agency.

19. The method according to claim 1 wherein the method comprises a further step to allow respondents' to save the survey on computer discs, or to email, or to upload.

20. The method according to claim 1 wherein the method comprises a further step to preserve information for future reference so respondents' do not have to re-fill out the portions of the survey which have not changed, such as name, and perhaps title, address, phone, stock investments.
